(19) United States
(12) Patent Application Publication
(10) Pub. No.: US 2006/0087418 A1
(43) Pub. Date: Apr. 27, 2006

(54) Pressure-detecting sensor

(75) Inventor: Masayoshi Takeuchi, Kariya-shi (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: AISIN SEIKI KABUSHIKI KAISHA, Kariya-shi (JP)

(21) Appl. No.: 11/256,984

(22) Filed: Oct. 25, 2005

(30) Foreign Application Priority Data
Oct. 27, 2004 (JP) 2004-313068

(51) Int. Cl. B60Q 1/00

(52) U.S. Cl. 340/438

(57) ABSTRACT

A pressure sensitive sensor includes a base member, a supporting member connected to one end of the base member and deformable upon receipt of a pressure, and a piezoelectric sensor provided in the supporting member.

### CROSS-REFERRENCE TO RELATED APPLICATION

This application is based on and claims priority under U.S.C.§119 to Japanese Patent Application 2004-313068, filed on Oct. 27, 2004, the entire content of which is incorporated herein by reference.

### FIELD OF THE INVENTION

The present invention is directed to a pressure sensitive sensor having a sensor element that is connected to a base member via a supporting member and designed to react upon collision with an obstacle.

### BACKGROUND OF THE INVENTION

In a sliding door device for vehicles, an electrically operated doorframe is provided at one side of a vehicle body for opening and closing door opening. Sometimes an obstacle such as a part of human body or foreign matter may be pinched between the door panel under closing movement and a doorframe defining the door opening. In such a case, for immediate release of the pinched condition, the door movement is controlled to reverse upon detection of the obstacle by a pressure sensitive sensor provided at a front end of the door panel.

Japanese Patent No. 3285330 discloses such a pressure sensitive sensor. This pressure sensitive sensor is in the form of a cord switch and includes a pair of parallely spaced lead electrodes extending in an elongated outer cover formed of non-conductive material. The presser sensitive sensor is secured to a front end of a door panel. If an obstacle is pinched between a door frame and the door panel under closing movement, the outer cover is deformed, which causes the lead electrodes to contact. Then, upon receipt of the resulting signal, a controller begins to stop and reverse the closing movement of the door panel, thereby releasing the pinched condition.

The above mentioned cord switch is in the form of an elongated structure, deforms to react when applied with an external force, and has to be wired or installed along curved portions other than the front end of the door panel of smooth surface. Thus, if the cord switch is wired along the curved portion, an expected force is applied to the cord switch to close, which causes the cord switch to react without an pinched obstacle between the door panel and the door frame. In addition, in the above mentioned cord switch, there is a time lag between the beginning of the pinched condition and the contact of the electrodes, resulting in delayed reversing the door panel. Such an expected reaction may occur if the cord switch is mounted to the door panel with an excessive pressure. Japanese Patent No. 3291233 also discloses a similar cord switch.

A need thus exists to provide a pressure sensitive sensor which is free from the aforementioned drawbacks.

### SUMMARY OF THE INVENTION

In accordance with a first aspect of the present invention is to provide a pressure sensitive sensor which comprises a base member, a supporting member connected to one end of the base member and deformed upon receipt of a pressure, and a piezoelectric sensor provided in the supporting member

### BRIEF DESCRIPTION OF THE DRAWINGS

These and other objects of the invention will become more apparent from the following embodiments of the invention with reference to the attached drawings in which:

FIG. 1 is a perspective view of a vehicle on which is mounted a pressure sensitive sensor according to a first embodiment of the present invention;

FIG. 2 is a horizontally sectional view of the pressure sensitive sensor shown in FIG. 1;

Firg. 3 shows how the FIG. 1-shown pressure sensitive sensor operates upon receipt of an external force;

FIG. 4 is a perspective view of an internal the FIG. 1-shown pressure sensitive sensor;

FIG. 5A is a perspective view of the piezoelectric sensor for revealing an inner structure thereof;

FIG. 5B is a perspective view of another piezoelectric sensor for revealing an inner structure thereof;

FIG. 6 is a perspective view of a pressure sensitive sensor according to a second embodiment of the present invention;

FIG. 7 is a perspective view of a pressure sensitive sensor according to a third embodiment of the present invention; and

FIG. 8 is a perspective view of a pressure sensitive sensor according to a fourth embodiment of the present invention.

### DETAILED DESCRIPTION OF THE INVENTION

Hereinafter embodiments of the present invention will be described in great detail with reference to the attached drawings.

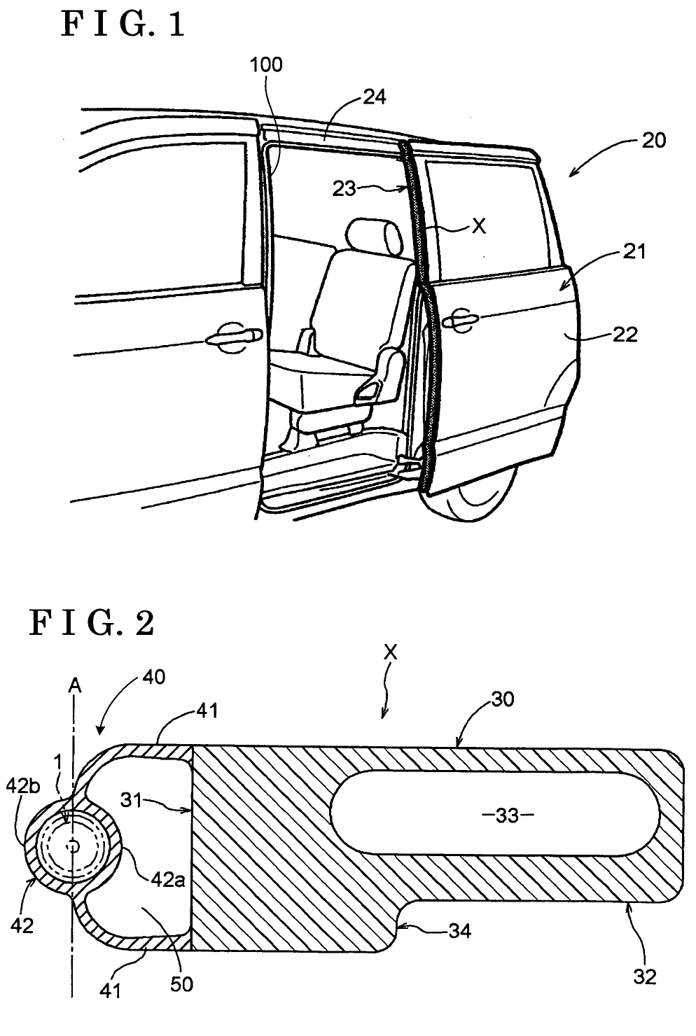

First of all, referring to FIG. 1, there is illustrated a van or vehicle 20 to which is provided a pressure sensitive sensor X of a first embodiment of the present invention. In detail, the van 20 has at its rear portion a door opening 24 that is opened and closed by an electrically operated sliding door 21 that includes a door panel 22. The door panel 22 has at its front end a vertically extending edge portion 23 along which the pressure sensitive sensor X is provided. The door opening 24 is defined by a frame 100. The door panel 22 is mounted on the frame 100 so as to be moved in the vehicular lengthwise direction.

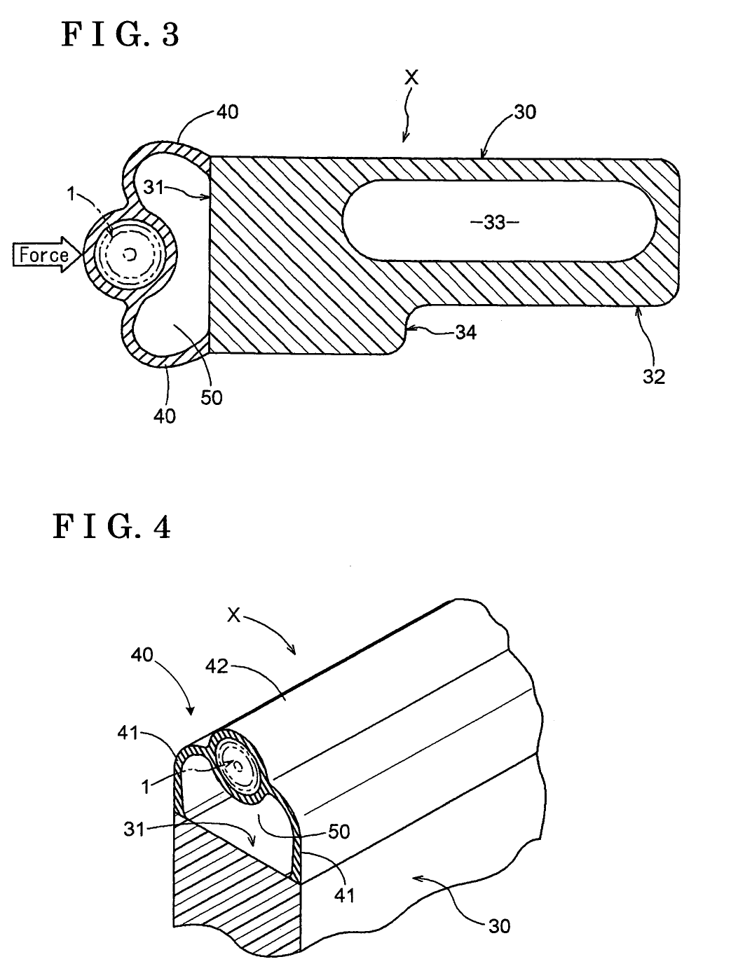

As shown in FIGS. 2 through 4, the pressure sensitive sensor X is, as a whole, formed into an elongate structure and is designed to react when a piezoelectric sensor 1, which is mounted to a base member 30 via a supporting member 40, abuts with an obstacle (not shown). The piezoelectric sensor 1 is capable of detecting an object by bending somewhat when being contact with the object. The supporting member 40 is lower than the base member 30 in material rigidity. The supporting member 40 is shaped into a curved structure when viewed in the vehicular rearward direction (in the rightward direction in FIG. 2).

The base member 30 is provided at one end thereof with the supporting member 40 holding therein the piezoelectric sensor 1. On the other hand, the base member 30 is formed at the other end thereof with a mounting surface 32 having a stepped portion 34. The stepped portion 34 is brought into engagement with the front surface 23 of the door panel 22 when the pressure sensitive sensor X is mounted to the door panel 22. The stepped portion 34 serves for positioning the base member 30 relative to the door panel 22.

The base member 30 is formed of a resin material with higher rigidity such a hard rubber for being connected strongly and durably to the door panel 22. Providing a hollow portion 33 make it possible to establish an even thermal distribution during solidification of the base member 30.

As is well known, when the sliding door 20 closes the door opening 24, the door panel 22 is brought into movement toward the door opening 24 at an angle with respect to the door frame 100.

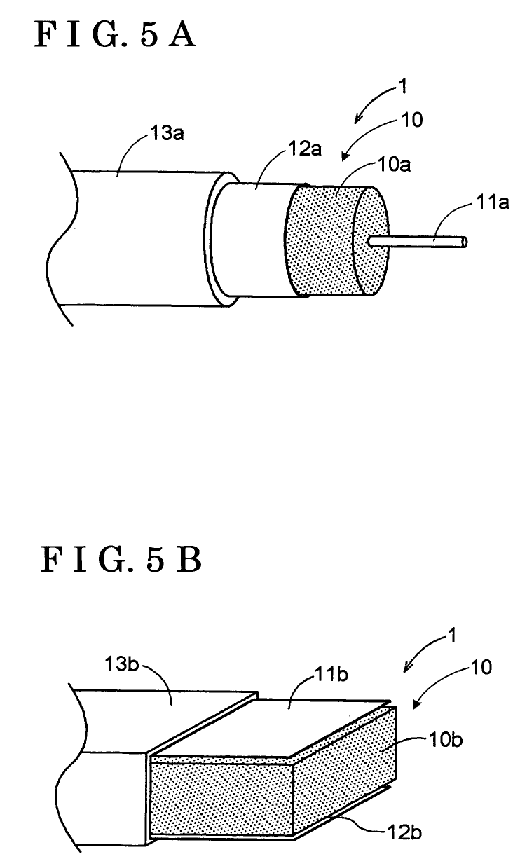

Referring now to FIG. 5A, there is schematically illustrated a structure of the piezoelectric sensor 1. The piezoelectric sensor 1 includes a first electrode (i.e. a central electrode) 11a that is formed of a conductive-wire wounded material, a second electrode (i.e. an outer electrode) 12a surrounding concentrically the first electrode (i.e. a central electrode) 11a, and an piezoelectric element 10a held between the electrodes 11a and 12a. The three concentrically layered members 11a, 10a, and 12a are covered with an outer tube 13a to form a co-axial cable structure or mode.

Instead of the structure shown in FIG. 5A, the piezoelectric sensor 1 may be in the form of a flat shape. In detail, the piezoelectric sensor 1 can be formed of a piezoelectric element 10b that is held or sandwiched between flat first and second electrodes 11b and 12b. The members 11b, 10b, and 12b are covered with an outer cover 13b. Thus constructed flat profile of the piezoelectric sensor 1 is preferable for being installed in a smooth elongated portion such as a door or a doorframe.

Forming the piezoelectric sensor 1 into coaxial cable form or flat cable for makes it possible to extend through a desired length and makes it also possible to run in non-linear or bending mode along a vehicular door or a vehicular doorframe. Running such structured piezoelectric sensor 1 in vehicles is made free from sensor-bend and/or sensor-mounting pressure, thereby establishing an easy mounting of the piezoelectric sensor 1 to the vehicle 20. The above two modes of the piezoelectric sensor 1 are illustrative, which allows the piezoelectric sensor 1 to employ other structure modes.

The piezoelectric element 1 is produced on the basis of the piezoelectric effect: When a crystal has a force applied to it, electrical charges are created. As the crystalline materials, quartz, PZT (i.e. lead zirconate titanate), barium titanate, etc are often employed. These crystalline materials also have pyroelectricity. Each of the first and second electrodes 11a (11b) and 12a (12b) may be formed of metal such as gold or cooper. The outer cover 13, which is in the form of a flexible, non-conductive, elongated (i.e. long-sized) tube, may be formed of synthetic resin or rubber.

The supporting member 40 serves for mounting the piezoelectric sensor 1 to the base member 30. The supporting member 40 is lower than the base member 30 in material rigidity. The supporting member 40 is shaped into a curved structure when viewed in the vehicular rearward direction (in the rightward direction in FIG. 2).

The supporting member 40 includes a cylindrical portion 42 in which the piezoelectric sensor 1 is held or accommodated. The cylindrical portion 42 is formed integrally with a pair of legs 41 and 41 to connect to the base member 30. The cylindrical portion 42 and its integral legs 41 and 41 cooperate with the base member 30 to define a space or hollow portion 50. The space 50 allows the cylindrical portion 42 and its integral legs 41 and 41 to deform. An overall outer periphery of the cylindrical portion 42 has a pair of points from which the pair of the legs 41 and 41 extend to the base member 30. The pair points are at a side of a front surface 31 of the base member 30 with respect to an imaginary plane A passing through the center of the cylindrical member 42 in parallel to a front surface 31 of the base member 30. The outer periphery of the cylindrical portion 42 is divided into two parts 42a and 42b.

Such a support of the piezoelectric sensor 1 at both sides thereof by the pair legs 41 and 41 is made stable, which prevents an excess displacement of the piezoelectric sensor 1 in the vertical direction in FIG. 2 (i.e. vehicular in-and-out direction). Of course, a sole leg (not shown) can support the cylindrical portion 42. The supporting member 40 and the base member 30 can be integral with each other or separate to each other. In the latter, the legs 41 and 41 of the supporting member 40 are coupled or adhered, by bonding agent, to a connecting surface of the base member 30.

As previously described, the supporting member 40 is lower in material rigidity than the base member 30. This design concept is to establish an earlier deformation of the supporting member 40 than the base member 30 when an external force is applied to the pressure sensitive device X. Thus, so long as such a rigidity relationship is established between the members 30 and 40, the base member 30 may be either identical with or different from the supporting member 40 in raw material.

As previously described, the supporting member 40 is shaped to have a cross-section along its lengthwise direction for easy deformation upon receipt of any directional external force.

Thus, the supporting member 40 of the pressure sensitive sensor X, which makes it easy for the piezoelectric sensor 1 held in the supporting member 40 to deform, resulting in an earlier or prompt detection an object from which the external force is applied to the piezoelectric sensor 1 with higher accuracy.

The above easy deformations of the legs 41 and 41 allow the piezoelectric sensor 1 to move, to some extent, toward the base member 30. This results in absorption of shock upon collision of the obstacle with the door panel 22 that is being in closing movement. In addition, even though the door panel 22 continues to move by inertia after collision thereof with the obstacle (i.e. after detection of the obstacle), while the movement of the supporting member 40 with the piezoelectric sensor 1 toward the base member 30, an entrapment (i.e. a pinched state) prevention control can be established. That is, before an application of reaction force from the base member 30 of higher rigidity to the obstacle, reversing the door panel 22 is made possible, thereby preventing an entrap of the obstacle between the door flame 100 and the pressure sensitive sensor X when the door panel 22 is in its closing movement.

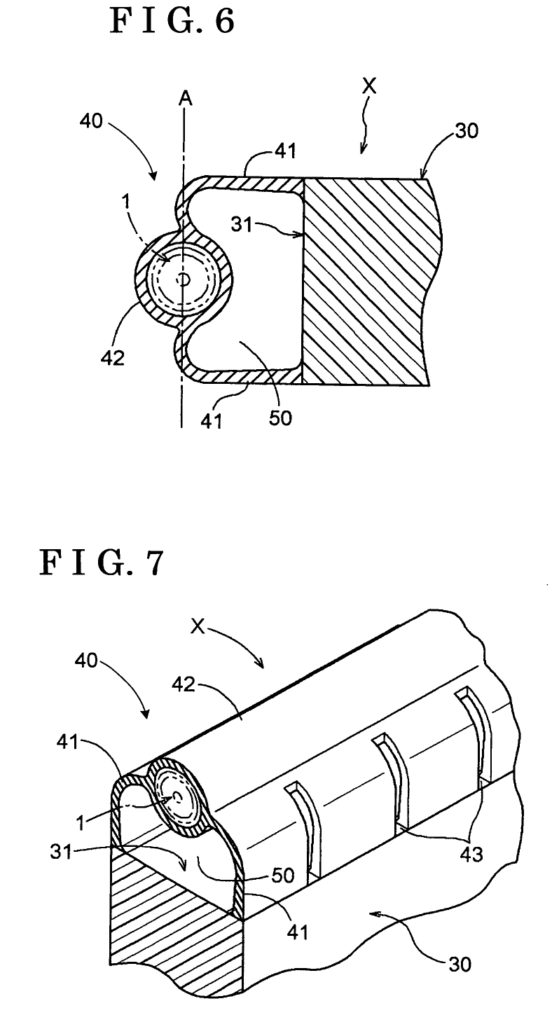

Referring to FIG. 6, there is illustrated a second embodiment of the present invention, wherein the pair of the legs 41 and 41 extends from the cylindrical portion 42 to the base member 30 after running along the plane A. Such a structure avoids that collision direction equals the extending direction of the leg 41, which makes the legs 41 and 41 much easier than the FIG. 2-structure.

With reference to FIG. 7, a third embodiment of the present invention is illustrated wherein each of the legs 41 and 41 is formed therein with a plurality of lengthwise equally pitched slits 43. Such a structure provides a partial deformation of the leg 41, resulting in that a portion of the leg 41 that is near the pinched obstacle is made to deform, thereby reacting the piezoelectric sensor 1 very quickly.

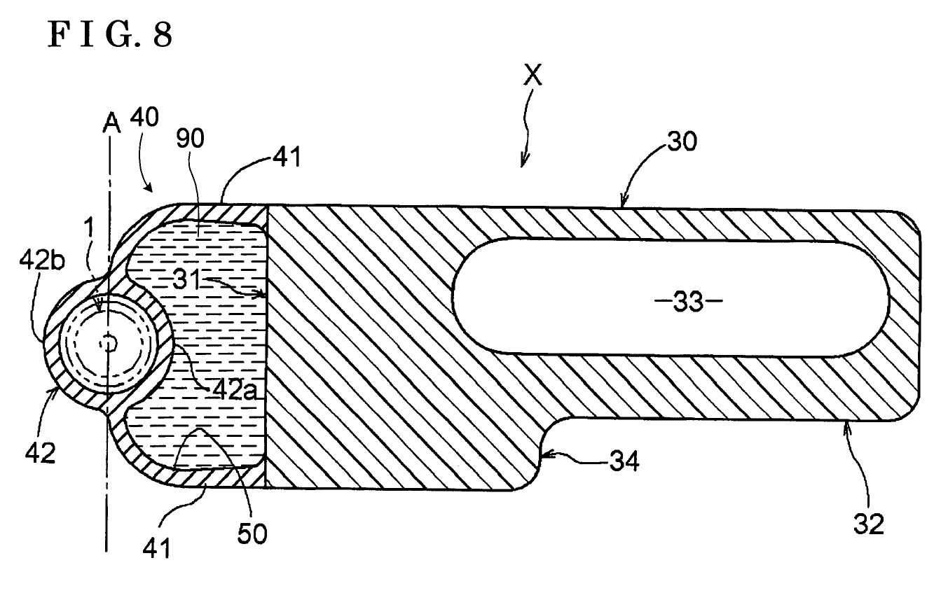

As shown in FIG. 8, there is illustrated a pressure sensitive sensor X according to a fourth embodiment of the present invention. This structure is identical with the FIG. 2-illustrated structure except that a medium is provided in the space 50 defined by the base member 30 and the integrated structure of the cylindrical portion 42 and the legs 41 and 41 of the supporting member 40. As the medium, any one of gas, solid, and liquid is available. For example, if the raw material of the base member 30 is ebonite or hard rubber, flexible rubber or soft rubber is available. As the medium 90, water, oil, and foamed material such as urethane foam are also available.

The FIG. 8-illustrated structure makes it possible to adjust the rigidity of the supporting member 40 relative to that of the base member 30. Thus, even if the deflection property of the piezoelectric sensor 1 that is held in the supporting member 40 varies, the rigidity of the resulting supporting member 40 can be adjusted to its optimum value. In addition, the mass of the obstacle to be in collision with the piezoelectric sensor 1 and the inertia upon such a collision varies depending on different places to which the pressure sensitive sensor X is mounted, the medium 90 absorbs the possible collision shock, thereby enabling an adequate adjustment of the deflection or deformation of the piezoelectric sensor 1.

Thus, the pressure sensitive sensor X having the FIG. 5-illustrated structure makes it possible to adjust the sensitivity of the piezoelectric sensor 1 at will or to a desired value, resulting in enhancement of the pressure sensitive sensor X in both sensitivity and accuracy.

It is to be noted that the pressure sensitive sensor of the present invention can be applied a sliding door of buildings or other facilities.

The principles, preferred embodiments and modes of operation of the present invention have been described in the foregoing specification. However, the invention which is intended to be protected is not to be construed as limited to the particular embodiments disclosed. Further, the embodiments described herein is to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A pressure sensitive sensor comprising:
a base member;
a supporting member connected to one end of the base member and deformable upon receipt of a pressure; and
a piezoelectric sensor provided in the supporting member.

2. A pressure sensitive sensor as set forth in claim 1, wherein the supporting member is lower than the base member in rigidity.

3. A pressure sensitive sensor as set forth in claim 1, wherein the supporting member is formed therein at least a space for making the supporting member lower than the base member in rigidity.

4. A pressure sensitive sensor as set forth in claim 3, wherein the at least the space passes fully through the supporting member along its lengthwise direction.

5. A pressure sensitive sensor as set forth in claim 3, wherein the at least the space is filled with a medium which is lower than the base member in rigidity.

6. A pressure sensitive sensor as set forth in claim 5, wherein the medium is selected from gas, solid, or liquid.

7. A pressure sensitive sensor as set forth in claim 5, wherein the medium is a soft rubber when the base member is formed of a rigid rubber.

8. A pressure sensitive sensor as set forth in claim 5, wherein the medium is a foamed urethane.

9. A pressure sensitive sensor as set forth in claim 1, wherein the supporting member is provided with a pair of spaced legs connected to one end of the base member to define a space, making the supporting member lower than the base member in rigidity.

10. A pressure sensitive sensor as set forth in claim 9, wherein the supporting member is formed into a columnar shaped to constitute an arch together with the pair of legs.

11. A pressure sensitive sensor as set forth in claim 9, wherein the at least the space passes fully through the supporting member along its lengthwise direction.

12. A pressure sensitive sensor as set forth in claim 11, wherein the at least the space is filled with a medium which is lower than the base member in rigidity.

13. A pressure sensitive sensor as set forth in claim 11, wherein the medium is selected from gas, solid, or liquid.

14. A pressure sensitive sensor as set forth in claim 11, wherein the medium is a soft rubber when the base member is formed of a rigid rubber.

15. A pressure sensitive sensor as set forth in claim 11, wherein the medium is a foamed urethane.

16. A pressure sensitive sensor as set forth in claim 1, wherein the supporting member is made of plural portions of different rigidities.

17. A pressure sensitive sensor as set forth in claim 1, wherein the supporting member has a non-planar outer surface along its lengthwise direction.

18. A pressure sensitive sensor as set forth in claim 1, wherein the supporting member is connected at the other end thereof to a moving member that is designed to move toward a mating member.

19. A pressure sensitive sensor as set forth in claim 18, wherein the moving member is a vehicular sliding door.
